(19) United States
(12) Patent Application Publication
(10) Pub. No.: US 2012/0050343 A1
(43) Pub. Date: Mar. 1, 2012

(54) DISPLAY APPARATUS AND DRIVING APPARATUS FOR DRIVING BACKLIGHT THEREOF

(75) Inventors: Tae-sung KIM, Suwon-si (KR); Sun-mi JUNG, Hwaseong-si (KR); Young-deok CHOI, Seoul (KR); Hyo-soon CHOI, Suwon-si (KR)

(73) Assignee: SAMSUNG ELECTRONICS CO., LTD., Suwon-si (KR)

(21) Appl. No.: 13/105,518

(22) Filed: May 11, 2011

(30) Foreign Application Priority Data
Aug. 31, 2010 (KR) 10-2010-0084725

(51) Int. Cl. G09G 5/10

(52) U.S. Cl. 345/690

(57) ABSTRACT

A display apparatus is provided with a backlight and a driving apparatus for driving the backlight, the driving apparatus including: a switching unit which performs a switching operation to selectively supply driving power to the backlight in accordance with a driving signal; a signal synthesizer which outputs a synthesized signal by synthesizing a current control signal which controls a level of a backlight current flowing in the backlight and a dimming signal which controls dimming of the backlight; and a driver which generates the driving signal so that the backlight current flowing in the backlight reaches a predetermined target level based on the synthesized signal, outputs the driving signal to the switching unit, and controls the dimming of the backlight based on the synthesized signal.

### CROSS-REFERENCE TO RELATED APPLICATION

This application claims priority from Korean Patent Application No. 10-2010-0084725, filed on Aug. 31, 2010 in the Korean Intellectual Property Office, the disclosure of which is incorporated herein by reference in its entirety.

### BACKGROUND

1. Field

Apparatuses and methods consistent with exemplary embodiments relate to a display apparatus provided with a backlight as a light source, and a driving apparatus for driving the backlight.

2. Description of the Related Art

A display apparatus such as a liquid crystal display (LCD) television (TV) or the like is provided with a backlight such as a light emitting diode (LED) as a light source of a display unit. To drive such a backlight, there is a need for a driving circuit. The driving circuit can drive the backlight by controlling an electric current flowing in a light emitting device such as the LED or the like.

The driving circuit of the display apparatus may be achieved by an integrated circuit (IC) for performing the foregoing current control. Such an IC for driving the backlight involves peripheral components. Therefore, as the scale of the IC for driving the backlight becomes larger, the number of peripheral components increases. Accordingly, the possibility that a defect occurs due to at least one of the peripheral components increases, and thus the quality of the display apparatus may be compromised.

### SUMMARY

Accordingly, one or more exemplary embodiments provide a display apparatus and a driving circuit device thereof, in which a circuit for driving a backlight has a minimum scale by decreasing the number of peripheral components so that costs can be reduced and quality of the display apparatus can be enhanced.

According to an aspect of an exemplary embodiment, there is provided a driving apparatus for driving a backlight provided in a display apparatus, the driving apparatus including: a switching unit which performs a switching operation to selectively supply driving power to the backlight in accordance with a driving signal; a signal synthesizer which outputs a synthesized signal by synthesizing a current control signal which controls a level of a backlight current flowing in the backlight and a dimming signal which controls dimming of the backlight; and a driver which generates the driving signal so that the backlight current flowing in the backlight reaches a predetermined target level based on the synthesized signal, outputs the driving signal to the switching unit, and controls the dimming of the backlight based on the synthesized signal.

The current control signal may include a current reference signal corresponding to the predetermined target level of the backlight current flowing in the backlight.

The driver may control the switching unit in accordance with a comparison result between a level of the synthesized signal and a level of a feedback signal of the backlight current flowing in the backlight, and control the backlight current to selectively flow in the backlight in accordance with duty of the synthesized signal.

The current control signal may include a feedback signal of the backlight current flowing in the backlight.

The driver may control the switching unit in accordance with a comparison result between a level of the synthesized signal and a level of a current reference signal corresponding to the target level of the backlight current flowing in the backlight, and control the backlight current to selectively flow in the backlight in accordance with a duty cycle of the synthesized signal.

The current control signal may include a deviation signal corresponding to a comparison result between a level of a current reference signal corresponding to the target level of the backlight current flowing in the backlight and a level of a feedback signal of the backlight current flowing in the backlight.

The driver may control the switching unit in accordance with the deviation signal, and control the backlight current to selectively flow in the backlight in accordance with duty of the synthesized signal.

The signal synthesizer may output the synthesized signal by synthesizing a protection signal which prevents an overcurrent from flowing in the backlight in addition to the dimming signal and the current control signal.

The driver may include one integrated circuit (IC) including an input pin which receives the synthesized signal.

According to an aspect of another exemplary embodiment, there is provided a driving apparatus for driving a backlight provided in a display apparatus, the driving apparatus including: a switching unit which performs a switching operation to selectively supply driving power to the backlight in accordance with a driving signal; a signal synthesizer which outputs a synthesized signal by synthesizing a current control signal which controls a level of a backlight current flowing in the backlight and a protection signal which prevents an overcurrent from flowing in the backlight; and a driver which generates the driving signal so that the backlight current flowing in the backlight reaches a predetermined target level based on the synthesized signal, outputs the driving signal to the switching unit, controls the dimming of the backlight based on a dimming signal, and selectively cuts off the backlight current flowing in the backlight based on the synthesized signal.

The current control signal may include a current reference signal corresponding to the predetermined target level of the backlight current flowing in the backlight.

The current control signal may include a feedback signal of the backlight current flowing in the backlight.

The current control signal may include a deviation signal corresponding to a comparison result between a level of a current reference signal corresponding to the target level of the backlight current flowing in the backlight and a level of a feedback signal of the backlight current flowing in the backlight.

The driver may include one integrated circuit (IC) including an input pin which receives the synthesized signal.

According to an aspect of another exemplary embodiment, there is provided a driving apparatus for driving a backlight provided in a display apparatus, the driving apparatus including: a switching unit which performs a switching operation to selectively supply driving power to the backlight in accordance with a driving signal; a signal synthesizer which outputs a synthesized signal by synthesizing a protection signal which prevents an overcurrent from flowing in the backlight and a dimming signal which controls dimming of the backlight; and a driver which generates the driving signal so that a backlight current flowing in the backlight reaches a predetermined target level, outputs the driving signal to the switching unit, and performs a dimming control for the backlight and a selective cutoff of the backlight current flowing in the backlight based on the synthesized signal.

The driver may include one integrated circuit (IC) including an input pin which receives the synthesized signal.

According to an aspect of another exemplary embodiment, there is provided a display apparatus including: a signal receiver which receives a video signal; a signal processor which processes the video signal received in the signal receiver; a display unit which displays an image based on the video signal processed by the signal processor, and includes a backlight for image displaying; and a driving circuit unit which drives the backlight, the driving circuit unit including: a switching unit which performs a switching operation to selectively supply driving power to the backlight in accordance with a driving signal; a signal synthesizer which outputs a synthesized signal by synthesizing a current control signal which controls a level of a backlight current flowing in the backlight and a dimming signal which controls dimming of the backlight; and a driver which generates the driving signal so that a backlight current flowing in the backlight reaches a predetermined target level based on the synthesized signal, outputs the driving signal to the switching unit, and controls the dimming of the backlight based on the synthesized signal.

According to an aspect of another exemplary embodiment, there is provided a display apparatus including: a signal receiver which receives a video signal; a signal processor which processes the video signal received in the signal receiver; a display unit which displays an image based on the video signal processed by the signal processor, and includes a backlight for image displaying; and a driving circuit unit which drives the backlight, the driving circuit unit including: a switching unit which performs a switching operation to selectively supply driving power to the backlight in accordance with a driving signal; a signal synthesizer which outputs a synthesized signal by synthesizing a current control signal which controls a level of a backlight current flowing in the backlight and a protection signal which prevents an overcurrent from flowing in the backlight; and a driver which generates the driving signal so that a backlight current flowing in the backlight reaches a predetermined target level based on the synthesized signal, outputs the driving signal to the switching unit, controls the dimming of the backlight based on a dimming signal, and selectively cuts off the backlight current flowing in the backlight based on the synthesized signal.

According to an aspect of another exemplary embodiment, there is provided a display apparatus including: a signal receiver which receives a video signal; a signal processor which processes the video signal received in the signal receiver; a display unit which displays an image based on the video signal processed by the signal processor, and includes a backlight for image displaying; and a driving circuit unit which drives the backlight, the driving circuit unit including: a switching unit which performs a switching operation to selectively supply driving power to the backlight in accordance with a driving signal; a signal synthesizer which outputs a synthesized signal by synthesizing a protection signal which prevents an overcurrent from flowing in the backlight and a dimming signal which controls dimming of the backlight; and a driver which generates the driving signal so that a backlight current flowing in the backlight reaches a predetermined target level, outputs the driving signal to the switching unit, and performs a dimming control for the backlight and a selective cutoff of the backlight current flowing in the backlight based on the synthesized signal.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram showing a configuration of a display apparatus according to an exemplary embodiment;

FIG. 2 is a circuit diagram showing a configuration of a driving circuit unit of the display apparatus shown in FIG. 1;

FIG. 3 is a circuit diagram showing a detailed configuration of a driver of the driving circuit unit shown in FIG. 2;

FIGS. 4 through 6 are circuit diagrams showing an example of a signal synthesizer of the driving circuit unit shown in FIG. 2; and

FIGS. 7 and 8 show other examples of the driver of the driving circuit units shown in FIG. 2.

### DETAILED DESCRIPTION OF EXEMPLARY EMBODIMENTS

Below, exemplary embodiments will be described in detail with reference to accompanying drawings. In the following description, like drawing reference numerals are used for the like elements, even in different drawings. The following description is provided to assist in a comprehensive understanding of exemplary embodiments. However, the exemplary embodiments can be practiced without specifically defined matters provided in the description and the description should not be read as limiting to those specifically defined matters. Also, well-known functions or constructions are not described in detail since they would obscure the application with unnecessary detail.

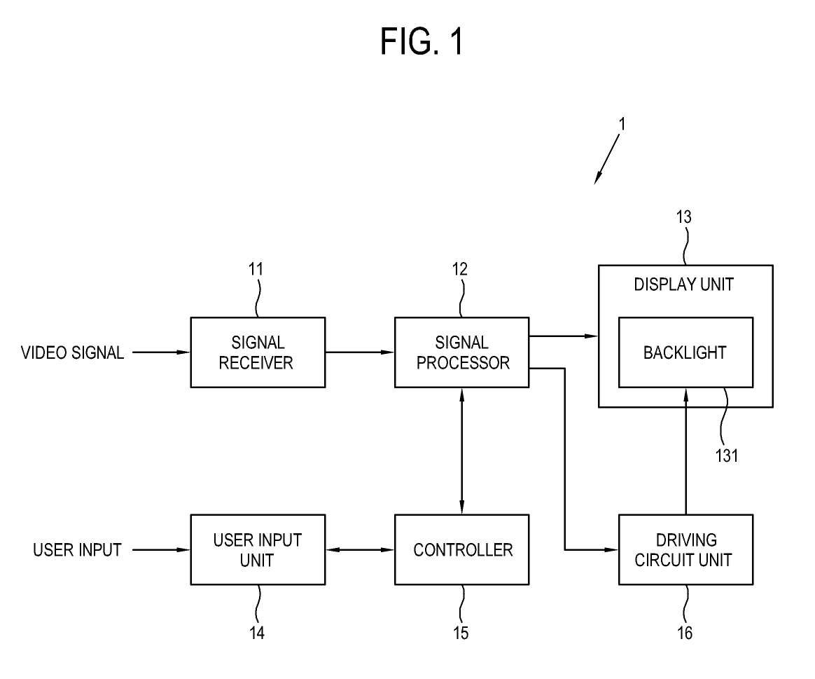

FIG. 1 is a block diagram showing a configuration of a display apparatus according to an exemplary embodiment. Here, a display apparatus 1 may be achieved by a television (TV). The display apparatus 1 includes a signal receiver 11, a signal processor 12, a display unit 13, a user input unit 14, a controller 15 and a diving circuit unit 16.

The signal receiver 11 receives a video signal containing video contents. Also, the video signal may contain audio contents and/or data contents as well as the video contents. The video signal received by the signal receiver 11 may include a broadcasting signal transmitted from a broadcasting station, and a signal output from a predetermined video device to the signal receiver 11. In the case of the broadcasting signal, the signal receiver 11 may selectively receive a broadcasting signal of one channel among a plurality of channels. The broadcasting signal may include any known broadcasting signal of public broadcasting, cable broadcasting, satellite broadcasting, or the like. Also, the kind of broadcasting signal may include digital broadcasting and analog broadcasting. The signal receiver 11 may perform signal processing to obtain video contents or the like from the received broadcasting signal. Such signal processing may include tuning, analog-digital conversion, demodulation, digital-analog conversion, etc.

In the case of a video signal output from a video device to the signal receiver 11, the signal receiver 11 may communicate with the video device, which transmits a video signal, in accordance with characteristics of the video signal. Such communication may include wired communication and wireless communication, and may also include analog communication and digital communication. Also, the type of communication may include any type of communication known to be used for transmitting the video contents or the like. There is no limit to the kind of video device that transmits a video signal to the signal receiver 11. For example, the video device includes a digital versatile disc (DVD) player, a Blu-ray disc (BD) player, a personal computer (PC), a mobile phone, a smart phone, other televisions, etc. The signal receiver 11 may perform signal processing to acquire video contents or the like from an input video signal. Such signal processing may include analog-digital conversion, digital-analog conversion, etc.

Further, the signal receiver 11 may receive a video signal from a predetermined server through a network, or receive a video signal from a portable storage device such as a universal serial bus (USB) memory. In each case, the signal receiver 11 may perform a given-type communication with a counterpart device so as to receive a video signal. In all cases, the signal receiver 11 may receive and process the video signal under control of the controller 15.

The signal processor 12 performs predetermined video processing so as to display video contents or the like obtained from a video signal received by the signal processor 11. Such video processing may include demultiplexing, decoding, scaling, image-quality adjustment, image-quality enhancement, etc. Also, the signal processor 12 may process an image related to a user interface (UI) menu for an interface with a user. The signal processor 12 may perform a process so that an image based on the video contents or the like and an image related to the UI menu are at least partially overlapped on one screen of the display apparatus or arranged in parallel with each other on the screen.

The display unit 13 displays an image processed by the signal processor 12. As shown in FIG. 1, the display unit 13 includes a backlight 131 as a light source. The backlight 131 may include at least one LED as a light emitting device. For example, the display unit 13 may include an LCD display panel (not shown) to display an image using light from the backlight 131.

The user input unit 14 receives a user's instruction, which can be achieved by a remote controller, a control panel, etc.

The controller 15 generally controls operation of the display apparatus 1. The controller 15 controls respective elements of the display apparatus 1 in accordance with a user's instruction input through the user input unit 14. The controller 15 may control the signal receiver 11 to receive a video signal desired by a user. The controller 15 may control the signal processor 12 to apply predetermined video processing to video contents and/or a UI menu obtained from a video signal received by the signal receiver 11. As necessary for performing such control, the controller 15 may store data in a storage unit (not shown) or read data from the storage unit. The storage unit is a non-transitory computer-readable storage medium which stores data.

The controller 15 may include a non-volatile memory in which an execution code of a computer program corresponding to the foregoing control is stored, a volatile memory to which the execution code stored in the non-volatile memory is at least partially loaded, and a microprocessor which executes the execution code loaded to the volatile memory.

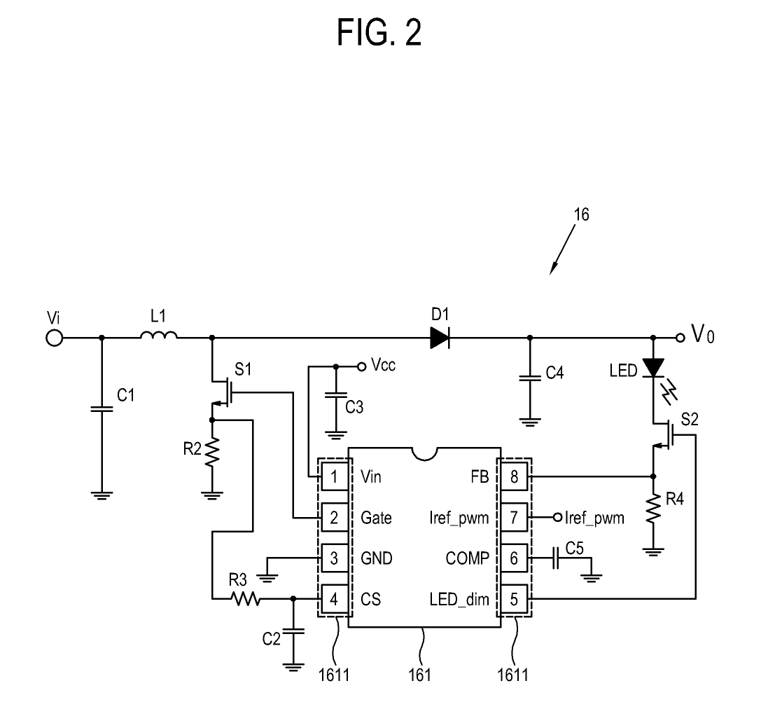

The display apparatus 1 includes a driving circuit unit 16 for driving the backlight 131. FIG. 2 is a circuit diagram showing a configuration of the driving circuit unit 16 according to an exemplary embodiment. As shown in FIG. 2, the driving circuit unit 16 receives input power Vi and converts it to thereby output driving power Vo for driving a backlight (refer to “LED” in FIG. 2).

The driving circuit unit 16 includes a driver 161 for controlling the driving power Vo; a switching unit L1, S1 for performing a switching operation to selectively send the input power Vi to an output terminal Vo under control of the driver 161; feedback units R2, R3 and C2 for sensing the intensity of an electric current flowing in a first switching device S1 and providing it to the driver 161; a second switching device S2 connected in series to the backlight (LED) and for performing a switching operation to selectively flow an electric current in the backlight (LED) under control of the driver 161; a feedback resistor R4 for providing a feedback signal corresponding to an electric current flowing in the backlight (LED) and the second switching device S2; a first capacitor C1 provided in the input terminal Vi; a fourth capacitor C4 provided in the output terminal Vo; a diode D1 for preventing a reverse current; a third capacitor C3 provided in a power supplying terminal Vcc of the driver 161; and a fifth capacitor C5 for maintaining an output level of a current controller (to be described later).

The first switching device S1 performs a switching operation on the basis of a first control signal received through a “Gate” pin of the driver 161. If the switching device S1 is turned on, the input power Vi is not supplied to the backlight (LED). On the other hand, if the switching device S1 is turned off, the input power Vi is supplied to the backlight (LED).

As shown in FIG. 2, the driver 161 may be achieved by an integrated circuit (IC) provided with eight pins 1611, for example. In FIG. 2, numerals show in respective pins 1611 denote pin numbers. Among the pins 1611, a “Vin” pin represents a power input terminal of the driver 161, a “Gate” pin represents an output terminal of the first control signal for driving the switching units L1 and S1, a “GND” pin represents the ground of the driver 161, a “CS” pin represents an input terminal of an electric current flowing in the switching device S1, an “LED_dim” pin represents an output terminal of a second control signal for driving the second switching device S2 to control dimming of the backlight (LED), a “COMP” pin represents a connection terminal for connecting with the fifth capacitor C5, an “Iref_pwm” pin represents an input terminal for a synthesized signal (to be described later), and an “FB” pin represents an input terminal of a feedback signal of an electric current flowing in the backlight (LED) and the second switching device S2.

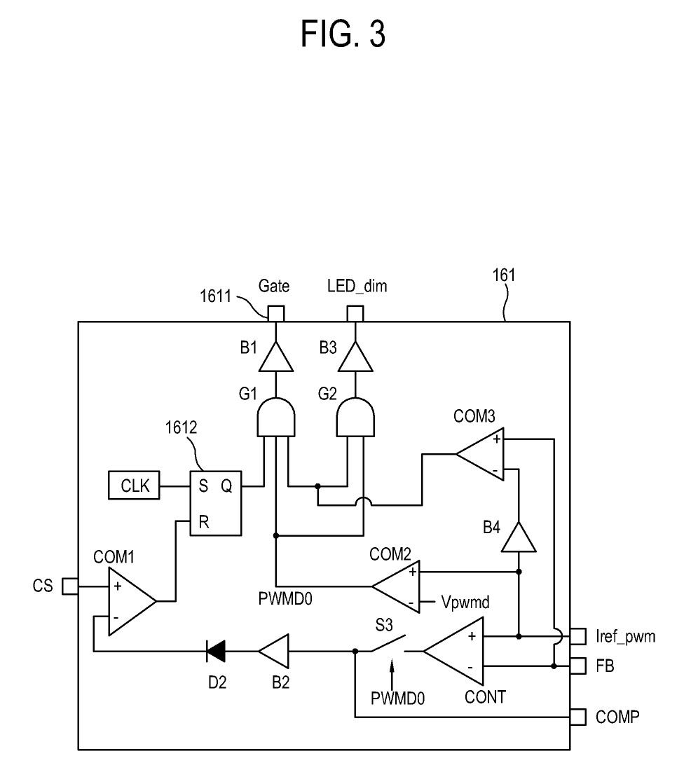

FIG. 3 is a circuit diagram showing a detailed configuration of a driver 161 of the driving circuit unit 16 shown in FIG. 2. In FIG. 3, some pins, such as Vin and GND, described with reference to FIG. 2 are omitted for convenience of illustration.

First, a level control for the electric current flowing in the backlight (LED) will be described. The driver 161 further includes a first gate G1, a first buffer B1, a flipflop 1612, and a clock generator CLK. The first gate G1 is achieved by an AND gate. The first buffer B1 receives the output of the first gate G1 and outputs a first control signal through the “Gate” pin. The clock generator CLK outputs a clock signal having a predetermined frequency to a set terminal S of the flipflop 1612. Thus, the output Q of the flipflop 1612 is maintained high until a high signal is input to a reset terminal R of the flipflop 1612.

Further, the driver 161 may include a current controller CONT to output a synthesized signal Iref_pwm and a deviation signal of a feedback signal FB of the electric current flowing in the backlight LED, and a first comparator COM1 to output a first comparative signal based on a comparison result of a sensing signal CS of the electric current flowing in the switching device 51 to the reset terminal R of the flipflop 1612. The driver 161 may further include a second diode D2 and a second buffer B2 between an output terminal of the current controller CONT and an input terminal of the first comparator COM1.

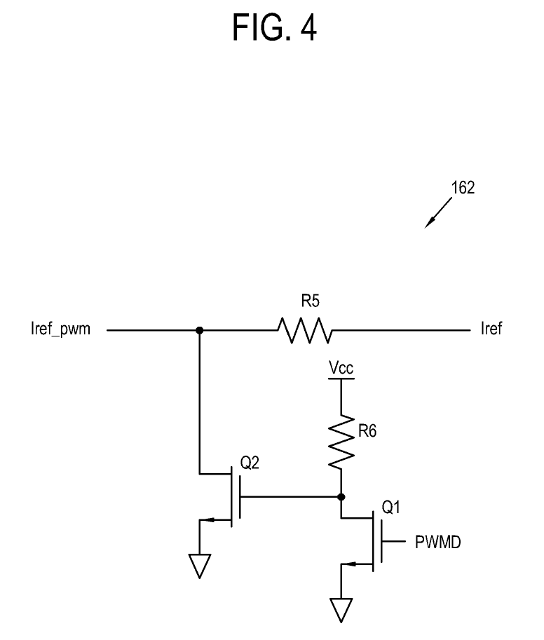

The driving circuit unit 16 further includes a signal synthesizer to generate and output the synthesized signal Iref_pwm. FIG. 4 is a circuit diagram showing an example of the signal synthesizer 162 according to an exemplary embodiment. As shown in FIG. 4, the signal synthesizer 162 may output the synthesized signal Iref_pwm by synthesizing (i.e., combining) a dimming signal PWMD for controlling the dimming of the backlight LED and a current reference signal Iref for controlling the level of the electric current flowing in the backlight LED. The dimming signal PWMD is a pulse width modulation (PWM) signal provided by the signal processor 12 and has a duty cycle set to control a flicker of the backlight (LED) in accordance with a video signal. The current reference signal Iref is a reference signal having a level set to make the electric current flowing in the backlight LED have a predetermined target level.

The signal synthesizer 162 includes a fifth resistor R5, a first field effect transistor (FET) Q1, a second FET Q2, and a sixth resistor R6. The first FET Q1 is turned on when the dimming signal PWMD is high, but off when low. The second FET Q2 is turned off when the first FET Q1 is turned on, but turned on when the first FET Q1 is turned off. The current reference signal Iref is connected to an output terminal Iref_pwm of the signal synthesizer 162 via the fifth resistor R5, and the synthesized signal Iref_pwm has substantially the same level as the current reference signal Iref when the second FET Q2 is turned off. On the other hand, if the second FETQ2 is turned on, the output terminal of the signal synthesizer 162 is grounded so that the level of the synthesized signal Iref_pwm becomes 0 or low. That is, the synthesized signal Iref_pwm has the same frequency and duty cycle as the dimming signal PWMD, and has the same level as the current reference signal Iref in a high state.

Referring back to FIG. 3, the current controller CONT outputs a deviation signal corresponding to level difference between a current reference of the synthesized signal Iref_pwm and the feedback signal FB of the electric current flowing in the backlight LED. The first comparator COM1 compares the deviation signal with the sensing signal CS, and outputs the first comparative signal in accordance with the comparison result. The first comparative signal becomes high when the sensing signal CS has a higher level than the deviation signal, but low when the sensing signal CS does not have a higher level than the deviation signal. If the electric current flowing in the backlight LED has not yet reached a predetermined target level, the first comparative signal is low and the output Q of the flipflop 1612 is maintained high. At this time, the first switching device S1 continues to be turned off, so that the electric current flowing in the backlight LED increases. On the other hand, if the electric current flowing in the backlight LED reaches a predetermined target level, the first comparative signal is high and therefore the output Q of the flipflop 1612 is changed to be low. At this time, the first switching device S1 is turned on so that the electric current flowing in the backlight LED decreases. Thus, the first switching device S1 is turned on or off under control of the current controller CONT and the first comparator COM1, so that the electric current flowing in the backlight LED can reach a predetermined target level by altering between increasing and decreasing.

Next, the dimming control of the backlight LED will be described. The driver 161 further includes a second comparator COM2 for controlling the dimming of the backlight LED, a second gate G2, and a third buffer B3. The second comparator COM2 compares the synthesized signal Iref_pwm and a dimming reference Vpwmd and outputs a second comparative signal PWMD0 to the second gate G2 in accordance with a comparison result. The second gate G2 is achieved by an AND gate, and the third buffer B3 receives the output of the second gate G2 and outputs a second control signal to the second switching device S2 via the “LED_dim” pin.

The second comparative signal PWMD0 becomes high when the synthesized signal Iref_pwm has a higher level than the dimming reference Vpwmd, but low when the synthesized signal Iref_pwm does not have a higher level than the dimming reference Vpwmd. Since the synthesized signal Iref_pwm has the same frequency and duty cycle as the dimming signal PWMD, the second switching device S2 is turned on in a section where the dimming signal PWMD has a high level so that a normal electric current flows in the backlight LED. On the other hand, the second switching device S2 is turned off in a section where the dimming signal PWMD has a low level, so that no electric current flows in the backlight LED. That is, the backlight LED flickers in accordance with the duty cycle of the dimming signal PWMD.

Also, the second comparative signal PWMD0 is connected to any one input terminal of the first gate G1. Accordingly, if the backlight LED is turned off in the section where the dimming signal PWMD has a low level, the first switching device S1 is also turned on at the same time so that the input power Vi can be prevented from being unnecessarily supplied to the backlight LED.

In the meantime, because the synthesized signal Iref_pwm has a section where it is low, the synthesized signal Iref_pwm cannot serve as the current reference in this section. In this regard, the driver 161 may further include a switch S3 connected to the output terminal of the current controller CONT and opened/closed in accordance with the second comparative signal PWMD0. If the second comparative signal PWMD0 has a high level, the switch S3 is turned on. On the other hand, if the second comparative signal PWMD0 has a low level, the switch S3 is turned off. If the switch S3 is turned on, the deviation signal of the current controller CONT is normally transmitted to the first comparator COM1. If the switch S3 is turned off, the deviation signal is not directly transmitted to the first comparator COM1. Instead, when the switch S3 is turned on, the fifth capacitor C5 connected to the “COMP” pin is electrically charged by the output deviation signal. Thus, when the switch S3 is turned off in a section where the dimming signal PWMD is low, the charge stored in the fifth capacitor C5 may be discharged as the deviation signal to the first comparator COM1 even though the synthesized signal Iref_pwm does not provide the current reference.

Thus, in the driving circuit unit 16 described with reference to FIGS. 2 to 4, two signals for driving the backlight LED, i.e., the current reference signal Iref and the dimming signal PWMD are synthesized to generate one synthesized signal Iref_pwm, and the synthesized signal Iref_pwm is provided to the driver 161, thereby simplifying a circuit configuration of the driver 161, reducing costs, and enhancing quality. For example, if the driver 161 is achieved by an integrated circuit (IC), two pins are needed for respectively receiving the current reference signal Iref and the dimming signal PWMD. However, in this exemplary embodiment, one pin Iref_pwm for receiving the synthesized signal is enough to configure the circuit.

In another exemplary embodiment, the driver 161 may further include a third comparator COM3 and a fourth buffer B4. The third comparator COM3 may control the first switching device 51 and the second switching device S2 on the basis of the synthesized signal Iref_pwm and the feedback signal FB.

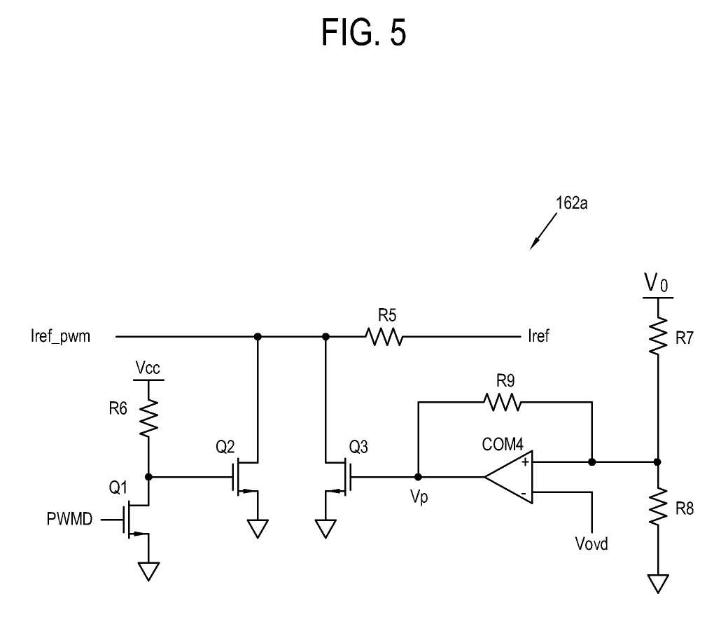

FIG. 5 is a circuit diagram showing a signal synthesizer 162a according to another exemplary embodiment. With regard to the signal synthesizer 162a shown in FIG. 5, repetitive descriptions of the same or similar configurations as those of the signal synthesizer 162 shown in FIG. 4 will be avoided. The signal synthesizer 162a shown in FIG. 5 may further include a protection circuit unit having a fourth comparator COM4, a third FET Q3, and seventh to ninth resistors R7, R8 and R9 in addition to those of the signal synthesizer 162 of FIG. 4.

The fourth comparator COM4 outputs a protection signal Vp in accordance with a comparison result between a feedback voltage of a voltage V0 at the output terminal of the driving circuit unit 16 (voltage applied to the eighth resistor R8) and a protection reference voltage Vovd. The third FET Q3 is turned on or off in accordance with a level of a protection signal Vp. If the third FET Q3 is turned on, the synthesized signal Iref_pwm becomes low. On the other hand, if the third FET Q3 is turned off, the synthesized signal Iref_pwm becomes a signal acquired by synthesizing the dimming signal PWMD as described with reference to FIG. 4 and the current reference signal Iref. Thus, if the electric current flowing in the backlight LED is lower than a normal level, the third FET Q3 is turned off so that the driving circuit unit 16 operates normally. On the other hand, if an overcurrent flows in the backlight LED, the level of the protection signal Vp is changed to turn on the third FET Q3, so that both the first and second switching devices S1 and S2 can operate to prevent the flow of the electric current in the backlight LED, thereby protecting the backlight LED and the driving circuit unit 16.

Thus, in accordance with the driving circuit unit 16 described with reference to FIGS. 2 to 5, one synthesized signal Iref_pwm is generated by synthesizing the protection signal Vp, the current reference signal Iref and the dimming signal PWMD, and the synthesized signal Iref_pwm is provided to the driver 161, thereby simplifying the configuration of the driver 161. In this exemplary embodiment, two IC pins are reduced to one in the driver 161 as compared with the number of IC pins needed in a driver when the current reference signal Iref, the dimming signal PWMD and the protection signal Vp are individually input.

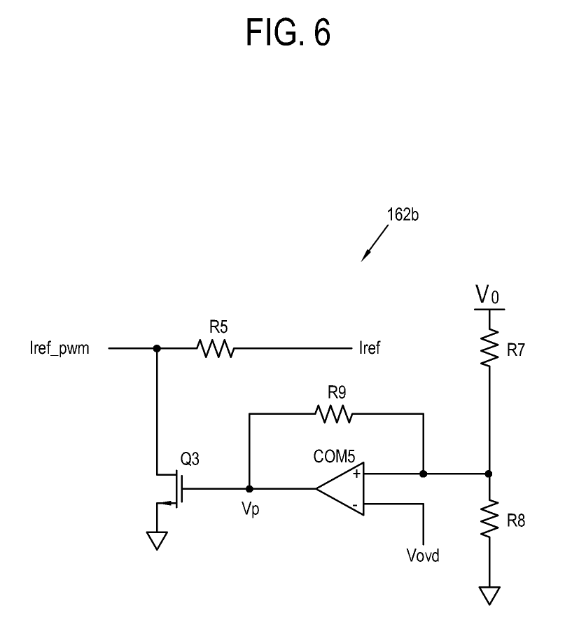

FIG. 6 is a circuit diagram showing a signal synthesizer 162b according to still another exemplary embodiment. The signal synthesizer 162b shown in FIG. 6 outputs the current reference signal Iref like the signal synthesizer 162 of FIG. 4, and one synthesized signal Iref_pwm in which the protection signal Vp is synthesized like the signal synthesizer 162a of FIG. 5. The configuration of the signal synthesizer 162b shown in FIG. 6 and its synthesizing principle for the synthesized signal Iref_pwm are similar to the configurations of the signal synthesizers 162 and 162a and their synthesizing principles, and thus repetitive descriptions thereof will be avoided.

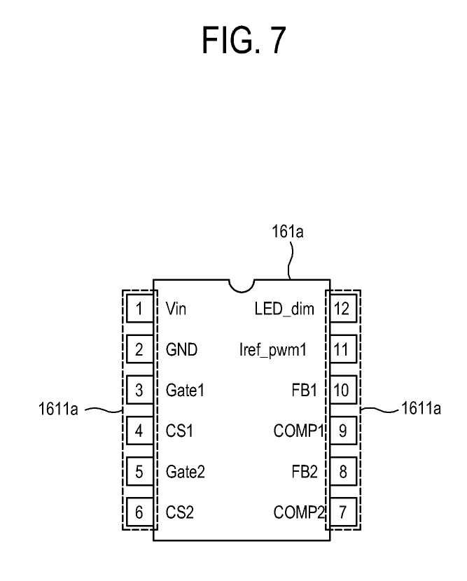

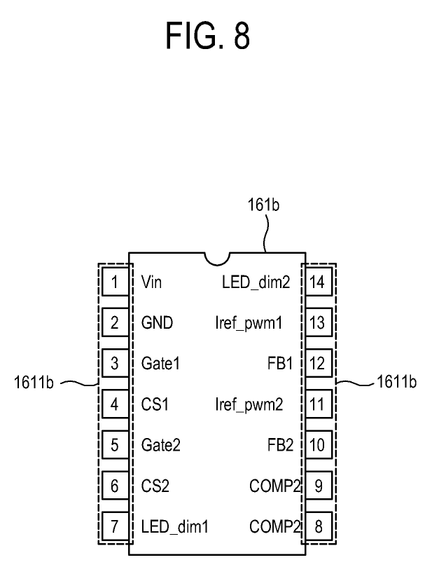

FIGS. 7 and 8 show other examples of driver 161, including drivers 161a and 161b according to other exemplary embodiments. The driver 161a shown in FIG. 7 and the driver 161b shown in FIG. 8 are achieved by the ICs, respectively. The driver 161a shown in FIG. 7 has twelve pins 1611a, and the driver 161b shown in FIG. 8 has fourteen pins 1611b. The driver 161a shown in FIG. 7 illustrates a circuit designed to independently drive two backlights (see “LEDs” of FIG. 2), and the driver 161b shown in FIG. 8 illustrates a circuit designed to independently control the PWM dimming of the two backlights (see “LEDs” of FIG. 2).

As described above, in accordance with the present exemplary embodiment, the number of IC pins for controlling the electric current flowing in the backlight is decreased, so that the size and costs of the IC can be reduced. Also, the number of peripheral components needed for a circuit to drive the backlight is decreased, so that the whole area and material costs of the driving circuit can be reduced. Also, the number of peripheral components is decreased, so that a defect due to at least one of the peripheral components can be reduced, thereby enhancing quality of the display apparatus.

In the foregoing exemplary embodiments, the current reference signal and the dimming signal are synthesized into a single synthesized signal Iref_pwm. Alternatively, the synthesis of the signals is not limited thereto, and two or more signals input to the driver achieved by a separate device may be synthesized by various combinations. For example, at least one of the current reference signal, the feedback signal (refer to “FB” in FIG. 2) of an LED current, and the output (refer to “COMP” in FIG. 2) of the current controller may be synthesized with the dimming signal, and they may be synthesized with the protection signal.

The “current reference signal”, the “feedback signal” and the “deviation signal” mentioned in the above exemplary embodiments may be an example of the “current control signal” according to the exemplary embodiments.

As described above, in accordance with the exemplary embodiments, a circuit for driving a backlight has a minimum scale so that costs can be reduced by decreasing the number of peripheral components and quality of the display apparatus can be enhanced.

Although a few exemplary embodiments have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A driving apparatus for driving a backlight provided in a display apparatus, the driving apparatus comprising:
a switching unit which performs a switching operation to selectively supply driving power to the backlight in accordance with a driving signal;
a signal synthesizer which outputs a synthesized signal by synthesizing a current control signal which controls a level of a backlight current flowing in the backlight and a dimming signal which controls dimming of the backlight; and
a driver which generates the driving signal so that the backlight current flowing in the backlight reaches a predetermined target level based on the synthesized signal, outputs the driving signal to the switching unit, and controls the dimming of the backlight based on the synthesized signal.

2. The driving apparatus according to claim 1, wherein the current control signal comprises a current reference signal corresponding to the predetermined target level of the backlight current flowing in the backlight.

3. The driving apparatus according to claim 2, wherein the driver controls the switching unit in accordance with a comparison result between a level of the synthesized signal and a level of a feedback signal of the backlight current flowing in the backlight, and controls the backlight current to selectively flow in the backlight in accordance with a duty cycle of the synthesized signal.

4. The driving apparatus according to claim 1, wherein the current control signal comprises a feedback signal of the backlight current flowing in the backlight.

5. The driving apparatus according to claim 4, wherein the driver controls the switching unit in accordance with a comparison result between a level of the synthesized signal and a level of a current reference signal corresponding to the predetermined target level of the backlight current flowing in the backlight, and controls the backlight current to selectively flow in the backlight in accordance with a duty cycle of the synthesized signal.

6. The driving apparatus according to claim 1, wherein the current control signal comprises a deviation signal corresponding to a comparison result between a level of a current reference signal corresponding to the predetermined target level of the backlight current flowing in the backlight and a level of a feedback signal of the backlight current flowing in the backlight.

7. The driving apparatus according to claim 6, wherein the driver controls the switching unit in accordance with the deviation signal, and controls the backlight current to selectively flow in the backlight in accordance with a duty cycle of the synthesized signal.

8. The driving apparatus according to claim 1, wherein the signal synthesizer outputs the synthesized signal by synthesizing a protection signal which prevents an overcurrent from flowing in the backlight in addition to the dimming signal and the current control signal.

9. The driving apparatus according to claim 1, wherein the driver comprises one integrated circuit (IC) comprising an input pin which receives the synthesized signal.

10. A driving apparatus for driving a backlight provided in a display apparatus, the driving apparatus comprising:
a switching unit which performs a switching operation to selectively supply driving power to the backlight in accordance with a driving signal;
a signal synthesizer which outputs a synthesized signal by synthesizing a current control signal which controls a level of a backlight current flowing in the backlight and a protection signal which prevents an overcurrent from flowing in the backlight; and
a driver which generates the driving signal so that the backlight current flowing in the backlight reaches a predetermined target level based on the synthesized signal, outputs the driving signal to the switching unit, controls the dimming of the backlight based on a dimming signal, and selectively cuts off the backlight current flowing in the backlight based on the synthesized signal.

11. The driving apparatus according to claim 10, wherein the current control signal comprises a current reference signal corresponding to the predetermined target level of the backlight current flowing in the backlight.

12. The driving apparatus according to claim 10, wherein the current control signal comprises a feedback signal of the backlight current flowing in the backlight.

13. The driving apparatus according to claim 10, wherein the current control signal comprises a deviation signal corresponding to a comparison result between a level of a current reference signal corresponding to the predetermined target level of the backlight current flowing in the backlight and a level of a feedback signal of the backlight current flowing in the backlight.

14. The driving apparatus according to claim 10, wherein the driver comprises one integrated circuit (IC) comprising an input pin which receives the synthesized signal.

15. A driving apparatus for driving a backlight provided in a display apparatus, the driving apparatus comprising:
a switching unit which performs a switching operation to selectively supply driving power to the backlight in accordance with a driving signal;
a signal synthesizer which outputs a synthesized signal by synthesizing a protection signal which prevents an overcurrent from flowing in the backlight and a dimming signal which controls dimming of the backlight; and
a driver which generates the driving signal so that a backlight current flowing in the backlight reaches a predetermined target level, outputs the driving signal to the switching unit, and performs a dimming control for the backlight and a selective cutoff of the backlight current flowing in the backlight based on the synthesized signal.

16. The driving apparatus according to claim 15, wherein the driver comprises one integrated circuit (IC) comprising an input pin which receives the synthesized signal.

17. A display apparatus comprising:
a signal receiver which receives a video signal;
a signal processor which processes the video signal received in the signal receiver;
a display unit which displays an image based on the video signal processed by the signal processor, and comprises a backlight for image displaying; and
a driving circuit unit which drives the backlight, the driving circuit unit comprising:
a switching unit which performs a switching operation to selectively supply driving power to the backlight in accordance with a driving signal;
a signal synthesizer which outputs a synthesized signal by synthesizing a current control signal which controls a level of a backlight current flowing in the backlight and a dimming signal which controls dimming of the backlight; and
a driver which generates the driving signal so that the backlight current flowing in the backlight reaches a predetermined target level based on the synthesized signal, outputs the driving signal to the switching unit, and controls the dimming of the backlight based on the synthesized signal.

18. A display apparatus comprising:
a signal receiver which receives a video signal;
a signal processor which processes the video signal received in the signal receiver;
a display unit which displays an image based on the video signal processed by the signal processor, and comprises a backlight for image displaying; and
a driving circuit unit which drives the backlight, the driving circuit unit comprising:
a switching unit which performs a switching operation to selectively supply driving power to the backlight in accordance with a driving signal;
a signal synthesizer which outputs a synthesized signal by synthesizing a current control signal which controls a level of a backlight current flowing in the backlight and a protection signal which prevents an overcurrent from flowing in the backlight; and
a driver which generates the driving signal so that the backlight current flowing in the backlight reaches a predetermined target level based on the synthesized signal, outputs the driving signal to the switching unit, controls the dimming of the backlight based on a dimming signal, and selectively cuts off the backlight current flowing in the backlight based on the synthesized signal.

19. A display apparatus comprising:
a signal receiver which receives a video signal;
a signal processor which processes the video signal received in the signal receiver;
a display unit which displays an image based on the video signal processed by the signal processor, and comprises a backlight for image displaying; and
a driving circuit unit which drives the backlight,
the driving circuit unit comprising:
a switching unit which performs a switching operation to selectively supply driving power to the backlight in accordance with a driving signal;
a signal synthesizer which outputs a synthesized signal by synthesizing a protection signal which prevents an overcurrent from flowing in the backlight and a dimming signal which controls dimming of the backlight; and
a driver which generates the driving signal so that a backlight current flowing in the backlight reaches a predetermined target level, outputs the driving signal to the switching unit, and performs a dimming control for the backlight and a selective cutoff of the backlight current flowing in the backlight based on the synthesized signal.

20. The driving apparatus according to claim 1, wherein the synthesized signal is synthesized by combining the current control signal with the dimming signal such that the synthesized signal has a same frequency and duty cycle as the dimming signal, and, when in a high state, the synthesized signal has a same level as the current control signal.
